(19) United States
(12) Patent Application Publication
(10) Pub. No.: US 2015/0220956 A1
(43) Pub. Date: Aug. 6, 2015

(54) Creating Consumable Content with Embedded Codes, and Tracking use of Embedded Codes

(71) Applicant: Christopher P. Curtis, La Mesa, CA (US)

(72) Inventor: Christopher P. Curtis, La Mesa, CA (US)

(21) Appl. No.: 14/596,998

(22) Filed: Jan. 14, 2015

Related U.S. Application Data
(60) Provisional application No. 61/935,172, filed on Feb. 3, 2014.
(60) Provisional application No. 62/075,156, filed on Nov. 4, 2014.

(51) Int. Cl. G06Q 30/02; G06F 3/0483

(52) U.S. Cl. CPC G06Q 30/0215; G06F 3/0483

(57) ABSTRACT

Methods, systems, means and machine-readable media embodying program instructions for creating codes, creating content with the codes, and tracking use of the codes are described. Certain methods may generate a code that includes a number of characters, determine different sections in selected content at which to insert different characters of the code such that none of the characters will be inserted in the same section, and generate new content that includes each of the characters inserted at its respective section in the selected content.

### RELATED APPLICATIONS

This application relates to U.S. Patent Application Ser. No. 61/935,172, filed Feb. 3, 2014, entitled GIFT CARD BOOKS OR CODE SEARCHING BOOKS, the content of which is hereby incorporated by reference herein in its entirety.

This application relates to U.S. Patent Application Ser. No. 62/075,156, filed Nov. 4, 2014, entitled CREATING CONSUMABLE CONTENT WITH EMBEDDED CODES, AND TRACKING USE OF EMBEDDED CODES, the content of which is hereby incorporated by reference herein in its entirety.

### FIELD

Various embodiments relate to incentivizing consumers to view content, and more particularly, to systems, methods and machine-readable media for creating content with embedded codes for consumers, and for tracking use of those codes by consumers.

### BACKGROUND

With reading proficiency levels at some of the lowest levels in recorded history, solutions that embrace current technology are needed to encourage people of all ages and across many social and economic classes to engage in reading. Fortunately, this disclosure describes solutions that encourage reading by leveraging technology and human nature's tendency to seek rewards in exchange for effort.

### SUMMARY

Certain embodiments of this disclosure relate generally to systems (e.g., networks, devices, or device components), methods and machine-readable media for creating codes, creating content with the codes, and tracking use of the codes. Some systems, methods and machine-readable media may identify first content, generate a first code that includes a first number of characters, determine different sections in the first content at which to insert each character such that none of the characters will be inserted in the same section, and generate new content that includes each of the characters inserted at its respective section in the first content.

Some systems, methods and machine-readable media may generate a first identifier, associate the first identifier with the first code, receive a second identifier from a remote computing device, receive a set of characters from the remote computing device, compare the second identifier to the first identifier, compare the received set of characters to the characters of the first code if the second identifier and the first identifier match, and generate information that specifies a reward for a recipient who operates the remote computing device if the received set of characters match the first characters of the first code.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 depicts a network system within which aspects of the disclosure operate.

FIG. 2 depicts a device system within which aspects of the disclosure operate.

FIG. 3 depicts a device system within which aspects of the disclosure operate.

FIG. 4 illustrates a process for creating codes, creating content with the codes, and tracking use of the codes.

FIG. 5 illustrates a process for creating a code.

FIG. 6 illustrates a process for creating content with a code.

FIG. 7 illustrates a process for tracking user interaction in relation to use of a code.

Like reference numbers and designations in the drawings indicate like elements.

### DETAILED DESCRIPTION

### Example Systems

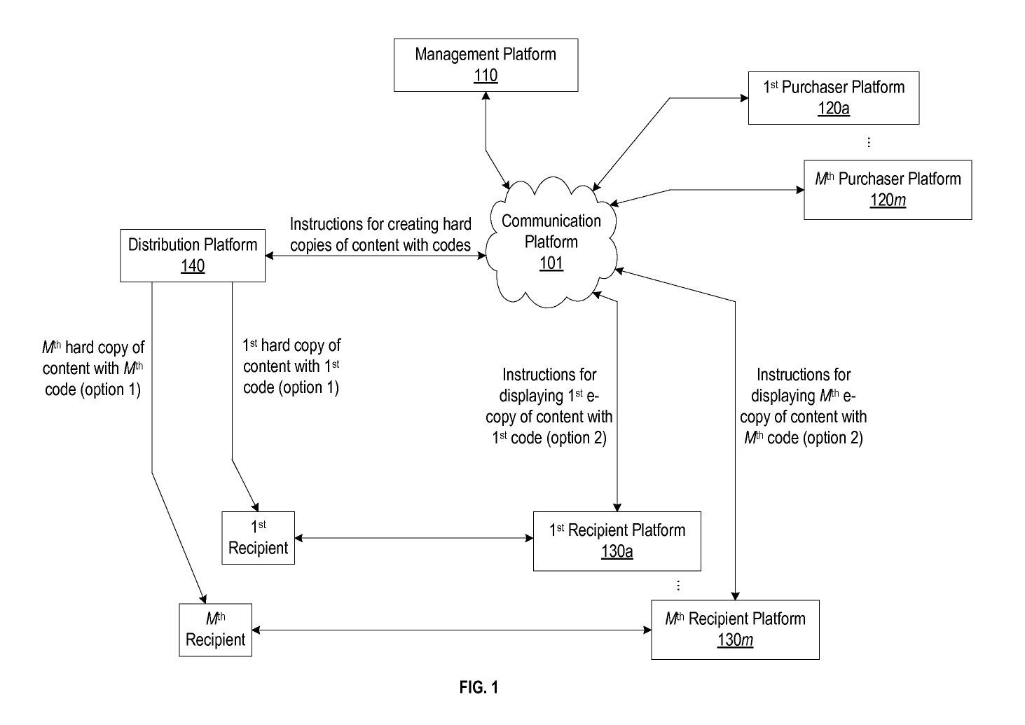

FIG. 1 depicts certain aspects of the disclosure relating to a system for creating codes, creating content with the codes, and tracking use of the codes.

The system may include various platforms, including a communication platform 101, a management platform 110, a purchaser platform 120, a recipient platform 130, and a distribution platform 140. The term “platform” as used herein may refer to a single device or component, or a grouping of devices or components at the same location or different locations. A platform may include components or devices that may be hosted by parties other than those directly associated with the labeling of each platform. Each platform may include hardware, software, firmware or other components that receive, process, store and send data. Each platform also may include any suitable computing device that is configured to allow an operator of that platform to view information and input selections, including any of numerous general purpose or special purpose computing systems like personal computers, hand-held or laptop devices, mobile phones, tablets, e-readers, touch-screen computing devices, and programmable consumer electronics. The platforms may use various software applications, including those that operate in conjunction with a web browser through a local area network connection or radio link, and those that operate without web connectivity.

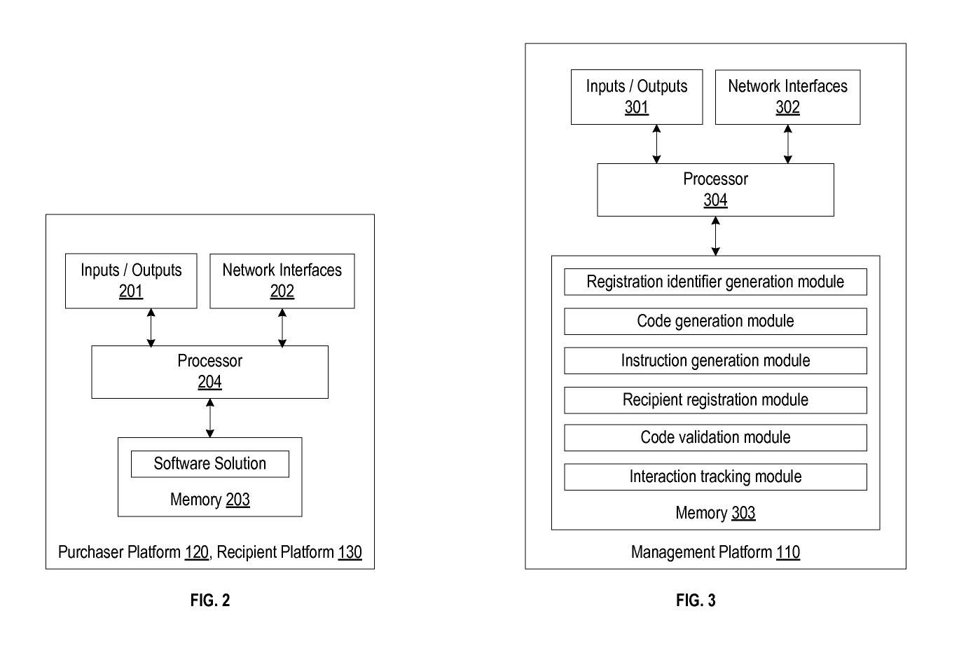

The purchaser platform 120 and recipient platform 130 each may include various components, including those depicted in FIG. 2, which includes input/output interface(s) 201 (e.g., keyboard, touch screen, speaker, microphone, or any other interface), network interface(s) 202 (e.g., wired and wireless means like radio antennas, USB ports, or any other transceiving hardware), temporary or long term memory 203, processor(s) or other computing components 204, and data source(s) 205 that include one or more storage devices. The platforms may further include a software solution stored in the memory 203, where the processor 204 executes instructions embodied in the software solution to implement any of the operations disclosed herein.

The management platform 120 may include various components, including those depicted in FIG. 3, which includes input/output interface(s) 301, network interface(s) 302, temporary or long term memory 303, processor(s) or other computing components 304, and data source(s) 305 that include one or more storage devices. The platforms may further include a software solution stored in the memory 303, where the processor 304 executes instructions embodied in the software solution to implement any of the operations disclosed herein. Various instruction modules are shown in FIG. 3. These modules relate to different methods disclosed below in the “Example Methodologies” section. As shown, the modules include: a module with instructions for generating a registration identifier; a module with instructions for generating a code; a module with instructions for generating instructions that control operations at a remote computing device (e.g., a recipient platform 130); a module with instructions for registering a recipient; a module with instructions for validating a code received from a recipient′ and a module with instructions for tracking a recipient's interaction with content.

Certain aspects of each platform are described in more detail below. It is to be understood that the description herein is not intended to be limiting, and alternative embodiments are contemplated as understood by one of skill.

### Communication Platform 101

The communication platform 101 utilizes any known or future communication technologies to facilitate communication among the various other platforms. Examples of communication technologies include any known or future wired and/or wireless communication pathways, protocols and infrastructure.

### Management Platform 110

The management platform 110 may be configured to identify content, generate a code, determine where to insert characters of that code into a digital copy of the content, insert the characters into the digital copy of the content to create new content, and/or provide a digital copy of the new content to a recipient platform 130 or the distribution platform 140.

The management platform 110 also may also be configured to receive a code from a recipient platform 130, compare that received code to stored codes, and provide reward information to the recipient platform 130 if the received code matches one of the stored codes.

Details regarding how each of the above activities is carried out by the management platform 110 are disclosed below in the “Example Methodologies” section.

### Purchaser Platform 120

The purchaser platform 120 is configured to interface with a purchaser who wants to buy content for consumption by a recipient. Details regarding how a purchaser uses the purchaser platform 120 are disclosed below in the “Example Methodologies” section.

### Recipient Platform 130

The recipient platform 130 is configured to interface with a recipient who consumes content and interacts with the content—e.g., who discovers a code in the content, and then inputs the code into the recipient platform 130, which in turn sends the inputted code to the management platform 110. Details regarding how a recipient uses the recipient platform 130 are disclosed below in the “Example Methodologies” section.

### Distribution Platform 140

The distribution platform 140 is configured to create a hard copy of content received from the management platform 110, and then provide the hard copy of the content to a recipient platform 130. By way of example, one type of distribution platform 140 may be operated by a publishing entity that publishes text, audio or video content, and provides access to the published content to the recipient platform 130. In one implementation, the distribution platform 140 is an entity that prints books and then mails the printed books to the recipient platform 130.

FIG. 1 depicts two implementations. In a first implementation, instructions for creating different hard copies of content with different codes are generated by the management platform 110, and transmitted to the distribution platform 140; the distribution platform 140 generates respective hard copies of respective content with a respective code, and provides each hard copy to a different recipient. In a second implementation, instructions for displaying different e-copies of content with different codes are generated by the management platform 110, and transmitted to respective recipient platforms 130a-m.

The above systems, or components thereof, may implement various methods that are described below.

### Example Methodologies

Various methods are described below in relation to creating codes, creating content with the codes, and/or monitoring use of the codes.

### Generation of Content Using a Code

In a first step of one embodiment, a purchaser selects content and inputs delivery information associated with an intended recipient of the content. Various sub-steps may be followed to carry out the first step. For example, the management platform 110 may receive a selection of content (e.g., a book) from a purchaser platform 120 operated by a purchaser. Payment information (e.g., credit card, e-payment like PayPal), a name of the recipient, and delivery information for the recipient (e g, mailing address, email, phone number, social media name) may also be received from the purchaser platform 120.

In a second step, a registration identifier is created and stored in a data source. Various sub-steps may be followed to carry out the second step. For example, the registration identifier may be generated, or it may be identified from a list of predefine registration identifiers. The registration identifier may comprise alphanumeric and/or symbol characters (e.g., A, a, 1, !), which may optionally include characters from any language and also any characters created in the future.

When the registration identifier is generated, a random set of characters may be used—e.g., a first identifier is aklepq or 103856, and a second identifier is qpekln or 306643). Alternatively, incremented numbers may be used—e.g., a first identifier is 000001, and second identifier is 000002. In one implementation, the registration identifier includes an image that can be scanned like a QR code.

Each generated registration identifier may be unique and never reused, or only active registration identifiers are unique such that the same registration identifier may be generated at different times so long as no two active registration identifiers are the same. An active registration identifier is a registration identifier that is associated with a code that has not been redeemed for a reward, which is a process that is described below.

In a third step a code is created and stored in the data source. Various sub-steps may be followed to carry out the third step. For example, the code may be generated, or it may be identified from a list of predefine codes. The code may comprise alphanumeric and/or symbol characters (e.g., A, a, 1, !), which may optionally include characters from any language and also any characters created in the future.

When the code is generated, a random set of characters may be used—e.g., a first code is pekfnqi or 5093756, and second code is kqlwodh or 0947255), or incremented numbers may be used—e.g., a first code is 0000001, and second code is 0000002. Alternatively, the purchaser may set the code, which could be a message for the recipient. The code may include any number of characters.

In one implementation, each generated code is compared to all previously-generated codes or all active codes to determine if the generated code is unique when compared to those previously-generated codes or active codes. If the generated code is not unique, a new code is generated until that newly generated code is unique.

In another implementation, a number n (e.g., 1012) between minimum and maximum numbers (e.g., 999 and 9999) is generated or otherwise selected, and a code is generated to include every n characters from the selected content. For example, a code generator (e.g., the processor 304) finds the 1012th letter in a selected book, and then adds that letter to the code as the first or any character of the code. The code generator then finds the 2024th letter in the book, and adds that letter to the code. The code generator continues in increments of 1012 letters until the code includes a predefined number of characters (e.g., seven characters), or until there are no more letters in the book. This approach for generating a code is possible for books of any number of characters.

The selected content also may be modified to identify the letters selected from the book so the recipient can identify those letters while reading the book. Such modification may include underlining, bolding, italicizing, capitalizing, animating like changing color or blinking (for e-books), rotating (e.g., by 90, 180 or 270 degrees), inverting (e.g., a backwards letter) and/or otherwise identifying those letters. In this way, modified content is created that designates the characters of the code.

In a similar implementation, every n characters from the book could be selected, where n changes after each selection—e.g., the first character of the code is the n=1012th character of the book, the second character of the code is the n=1345th character after the 1012th character in of the book, and so on until the code includes a predefined number of characters, or until there are no more characters in the book.

In another implementation, every nth character may be selected starting from the back of the book while advancing through character towards the front of the book.

Other implementations for generating a code do not depend on the selected content. In one such implementation, a code length is determined (e.g., seven characters), and then each character of a code is generated until the length of the code reaches the determined code length. Various approaches may be followed to generate each character of the code. For example, a random number between 1 and 26 may be generated, and a letter of the English alphabet that corresponds to that randomly generated number may be selected as a character for a new code, where A=1, B=2, . . . , and Z=26. This process may be repeated until the new code is created. In a similar implementation, the assignment of numbers 1 through 26 to letters of the English alphabet may be randomized when each character is generated such that A may correspond to 1 when a first character is generated, and A may correspond to 12 or another number when the second character is generated.

It is noted that the registration identifier and the code may be associated with each in the data source by any approach known in the art.

In a fourth step, a reproduction of content with the code (and optionally the registration identifier) is created. Various sub-steps may be followed to carry out the fourth step.

By way of example, each character of the code is included at a different part of the content, where each different part includes a different range of characters, a different range of words, a different range of lines, a different range of sentences, or a different range of pages of the reproduction.

In an implementation when the content is a work of literature (e.g., a book), each different part is determined based on a relationship between a total number of characters of the code and a total number of characters, words, lines, or pages of the content. The relationship may be is a ratio between the total number of characters of the code and the total number of characters, words, lines or pages of the content.

In an implementation when the content is audio or video content, each different part is determined based on a relationship between a total number of characters of the code and a total playback time of the content. The relationship may be a ratio between the total number of characters of the code and the total playback time of the content.

In another implementation, individual characters of the code may be added to pre-existing objects in the content (e.g., words, images, sounds). When the content is a book, for example, a code character (e.g., “z”) may be added to a word (e.g., “blatant”) in a way that creates a misspelling of that word (e.g., “blzatant” or “blZatant”). The recipient may later detect that character of the code by first identifying the misspelled word, and then determining which letter in the misspelled word should be removed to result in the correct spelling of the original word.

In yet another implementation, each character of the code may be repeated in capital letters (e.g., “HHH”) among other words of the content.

In another implementation, each character from the code may be paired with a number that identifies its position in the code. For example, if the code is “ZAFG”, then the following letter combinations may appear in the content: Z1, A2, F3 and G4. These combinations may also be placed with pre-existing objects (e.g., “examF3ple”). This typo would signify that “F” is the 3rd letter in the code. Use of the letter/number combination permits placement of the same code character in multiple places within the content (e.g., “F3” can be placed in the content multiple times to increase the chance that the recipient identifies the code character).

When the reproduction of the content is an e-book, the management platform 110 may generate software instructions that cause each character of the code to display on the recipient platform 130 depending on the recipient's interaction with the different parts of the e-book, where those software instructions are provided to the recipient platform 130.

When the reproduction of the content is a printed book, the reproduction is printed and mailed to the mailing address of the recipient.

Optionally, the management platform 110 may generate user instructions specifying how the recipient can retrieve each character of the code from the reproduction, and those instructions may be included in the reproduction.

### Confirmation of a Code Received from a Recipient

In a fifth step, the management platform 110 receives registration information from a recipient platform 130 operated by a recipient of the reproduction. The registration information may include the recipient's name and the recipient's delivery information if not already collected from the purchaser. A user account for the recipient also may be created based on the received registration information.

In a sixth step, a registration identifier is received by the management platform 110 from the recipient platform 130. In a seventh step, a code is received by the management platform 110 from the recipient platform 130. In an eighth step, the management platform 110 identifies a stored code that is associated with the received registration identifier, and compares the identified stored code with the received code.

In a ninth step, if the codes match, reward information (e.g., an electronic gift card associated with the registration identifier) is provided from the management platform 110 to the recipient platform 130. Otherwise, in a tenth step, if the codes do not match, no reward information is provided.

In one implementation where the reproduced content is lost, stolen or deemed unreadable for whatever reason, a recipient can request the same reproduction or a different reproduction of the content, after which the electronic gift card is associated with that new reproduction content. Thus, the registration identifier remains associated with the electronic gift card, which can be transferred from content to content.

### Tracking Recipient Interaction with Content

In an implementation when the reproduction is an e-book, recipient interaction with different parts of the reproduction is tracked by either the management platform 110 or the recipient platform 130. If predefined interactions are detected at different times, then either the management platform 110 or the recipient platform 130 cause different characters of the code to display after each detected interaction. By way of example, a first character of the code is displayed only after the recipient views a first part of the reproduction. By way of another example, a first character of the code is displayed only after the recipient views a first part of the reproduction for a predefined amount of time.

Various interaction may be tracked, including movement of the recipient's eyes via a camera on the recipient platform 130, which reveals a first character of the code only after the tracked movement of the recipient's eyes meets a condition (e.g., the movement demonstrates that the recipient has read certain words).

### Other Approaches

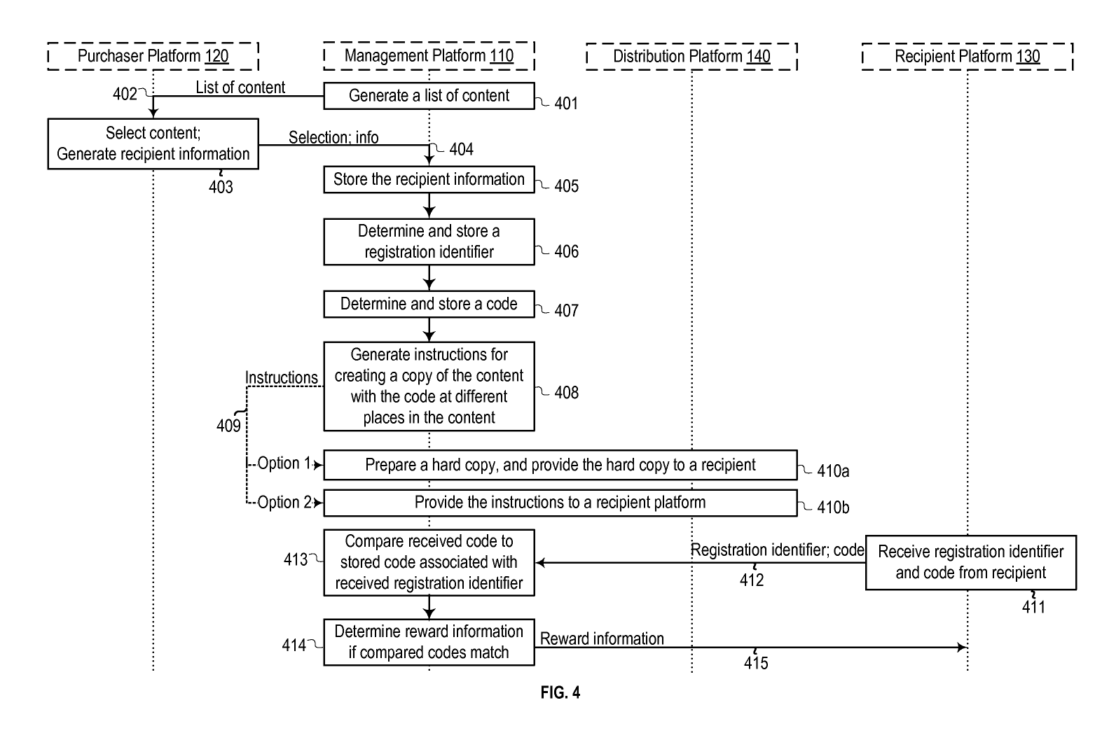

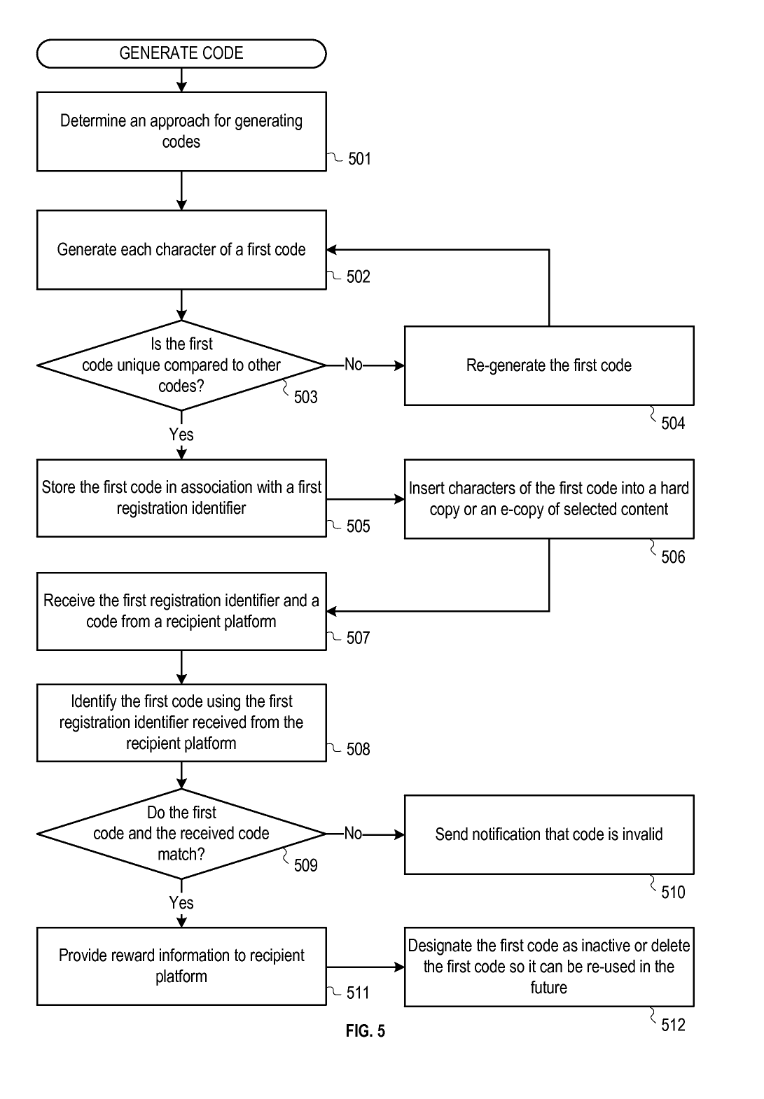

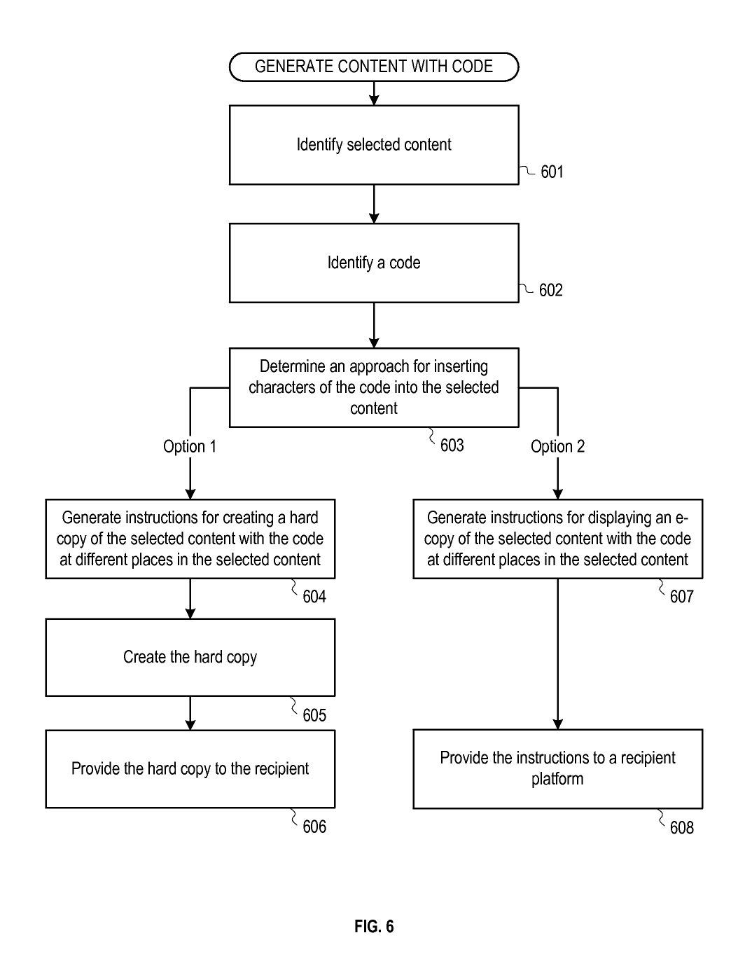

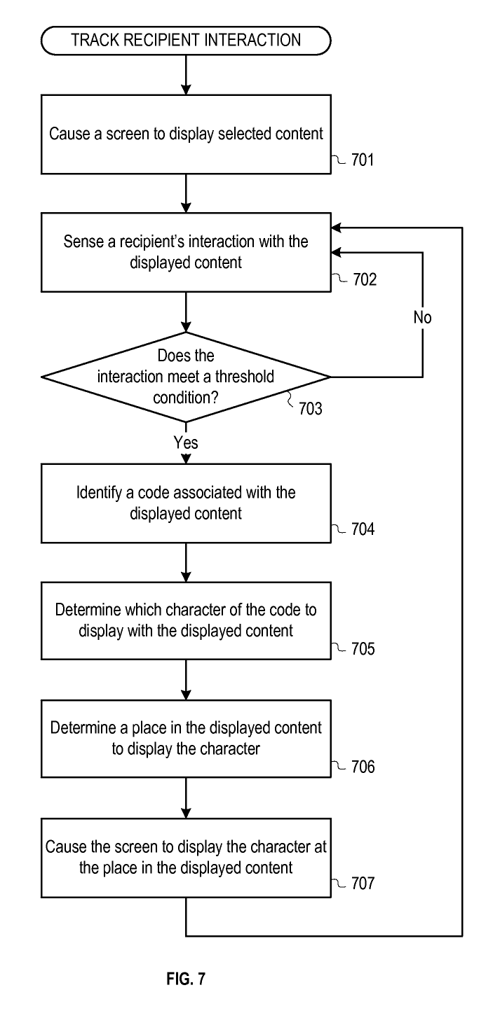

FIG. 4, FIG. 5, FIG. 6 and FIG. 7 each illustrate different processes for creating codes, creating content with the codes, and/or monitoring use of the codes in accordance with different aspects of the disclosure.

FIG. 4 illustrates a process for creating codes, creating content with the codes, and tracking use of the codes in accordance with aspects of the disclosure.

As shown, the management platform 110 generates a list of content (401). The list of content is transmitted to the purchaser platform 120 (402). The purchaser platform 120 selects content, and generates recipient information (403). The selected content and recipient information is transmitted from the purchaser platform 120 to the management platform 110 (404).

The management platform 110 stores the recipient information (405). The management platform 110 also determines and stores a registration identifier (406) and a code (407). The management platform 110 also generates instructions for creating a copy of the content with the code at different places in the content (408).

In a first implementation, a hard copy of the content with code is prepared by either the management platform 110 or the distribution platform 140 based on the instructions, and this hard copy is provided to a recipient (409a).

In a second implementation, the instructions are transmitted to a recipient platform 130, which presents the content with the code to a recipient (409b).

As the recipient views the content with the code, or after the recipient has viewed the content with the code, the recipient platform 130 receives a registration identifier and a code from the recipient (410). The received registration identifier and code are transmitted from the recipient platform 130 to the management platform 110 (411), and the management platform 110 compares the code to a stored code associated with received registration identifier (412). The management platform 110 then determines reward information if the compared codes match (413), and transmits the reward information to the recipient platform 130 (414).

Attention is now drawn to FIG. 5, which illustrates a process for creating a code.

As shown, the management platform 110 determines which approach to use for generating codes (501), after which the management platform 110 generates each character of a code based on that approach (502). The management platform 110 determines if the code is unique compared to other codes (503). If the code is not unique, the management platform 110 determines that another code is needed (504), and generates each character of another code (502). Once a code is determined to be unique, the management platform 110 stores that unique code in association with a registration identifier (505). The management platform 110 then inserts characters of the code into a hard copy or an e-copy of selected content (506).

At a later time, the management platform 110 receives the registration identifier and a code from a recipient platform (507). The management platform 110 identifies the stored code using the registration identifier received from the recipient platform (508), and determines if the received code matches the stored code (509). If there is no match, the management platform 110 sends notification to the recipient platform 130 that the received code is invalid (510). If there is a match, the management platform 110 sends notification to the recipient platform 130 that the code is provides reward information to recipient platform 130 (511), and then designates the stored code as inactive or deletes the stored code so it can be re-used in the future (512).

Attention is now drawn to FIG. 6, which illustrates a process for creating content with a code. As shown, the management platform 110 identifies selected content (601), identifies a code (602), and determines an approach for inserting characters of the code into the selected content (603).

In a first implementation, the management platform 110 generates instructions for creating a hard copy of the selected content with characters of the code at different places in the selected content (604), creates the hard copy (605), and provides the hard copy to a recipient (606).

In a second implementation, the management platform 110 generates instructions for displaying an e-copy of the selected content with characters of the code at different places in the selected content (607), and provides the instructions to a recipient platform (608).

Attention is now drawn to FIG. 7, which illustrates a process for tracking user interaction in relation to use of a code.

As shown, either the management platform 110 or the recipient platform 130 causes a screen to display selected content (701). The management platform 110 or the recipient platform 130 senses a recipient's interaction with the displayed content (702), and determines if the interaction meets a threshold condition (703). If the interaction does not meet the threshold condition, the management platform 110 or the recipient platform 130 senses another interaction by the recipient with the displayed content (702).

Once an interaction meets the threshold condition, the management platform 110 or the recipient platform 130 identifies a code associated with the displayed content (704), determines which character of the code to display with the displayed content (705), determines a place in the displayed content to display the character (706), and causes the screen to display the character at the place in the displayed content (707).

### Advantages of Methodologies

Practice of the methods disclosed herein offer the advantages over predecessor approaches of permitting a purchaser to incentivize a recipient to consume content (e.g., read a book) without further interaction between the purchaser and the recipient beyond initialing exchanging the content. Various methods disclosed herein improve the technical field of content creation and consumption by keeping consumers engaged with the content. Various methods disclosed herein use information in a new way that did not exist before this disclosure, including use of code segments at different parts of content, and/or identifying where to place those code segments based on characteristics of the content. Various methods disclosed herein generate new results that did not exist before this disclosure, including data files that include content and a code. Various aspects disclosed herein are non-conventional and not previously known to the book making industry. For example, codes are inserted into works of literature in an efficient way during production of a book such that different codes may be inserted in different copies of the same works of literature.

### Other Aspects Related to Systems & Methods

Functionality and operation disclosed herein may be embodied as one or more methods implemented, in whole or in part, by machine(s)—e.g., computing component(s), or other suitable means known in the art—at one or more locations, which enhances the functionality of those machines, as well as computing devices that incorporate those machines. Non-transitory machine-readable media embodying program instructions adapted to be executed to implement the method(s) are also contemplated. Execution of the program instructions by one or more computing components cause the computing components to carry out the method(s).

It is noted that method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time.

By way of example, not by way of limitation, method(s) and computing component(s) or other means may: identify first content; generate a first code that includes a first number of characters; for each of the characters, determine a section in the first content at which to insert that character such that none of the characters will be inserted in the same section; and generate new content that includes each of the characters inserted at its respective section in the first content.

Method(s) and computing component(s) or other means may further or alternatively: generate a first identifier; associate the first identifier with the first code; receive a second identifier from a remote computing device; receive a set of characters from the remote computing device; compare the second identifier to the first identifier; if the second identifier and the first identifier do not match, compare the second identifier to another identifier; if the second identifier and the first identifier match, compare the received set of characters to the characters of the first code; and if the received set of characters match the first characters of the first code, generate information that specifies a reward for a recipient who operates the remote computing device.

Method(s) and computing component(s) or other means may further or alternatively: transmit the new content to a printing device; and cause the printing device to print the new content.

In accordance with some aspects, the first content is a work of literature, and wherein each of the characters in the first code is inserted into a different word in the work of literature.

In accordance with some aspects, the first content is a work of literature, and wherein spacing between each consecutive section in the first content is based on the first number and a total number of words in the first content.

In accordance with some aspects, the first content is a work of literature, and wherein spacing between each consecutive section in the first content is based on the first number and a total number of sentences in the first content.

In accordance with some aspects, the first content is a work of literature, and wherein spacing between each consecutive section in the first content is based on the first number and a total number of pages in the first content.

Method(s) and computing component(s) or other means may further or alternatively: determine when each of the characters in the first code will display on a remote computing device at different times depending on different detected interactions between a recipient and the new content when displayed on the remote computing device.

Method(s) and computing component(s) or other means may further or alternatively: for each character of the characters in the first code, generate instructions that cause that character to display on a remote computing device only after a respective interaction between the recipient and the new content is detected by the remote computing device or the one or more computing devices.

An output from one system may cause another system to perform a method even if intervening steps occur between the output and performance of the method.

Any method step or feature disclosed herein may be expressly restricted from a claim for various reasons like achieving reduced manufacturing costs, lower power consumption, and increased processing efficiency.

The illustrative methods described herein may be implemented, performed, or otherwise controlled by suitable hardware known or future by one of ordinary skill in the art, or by firmware or software executed by computing component(s), or any combination of hardware, software and firmware. Software may be downloadable and non-downloadable at a particular system. Such software comprises a machine-implemented component that, once loaded on a machine like a computing component or a computer, changes the operation of that machine.

Systems on which methods described herein are performed may include one or more means that implement those methods. For example, such means may include computing component(s) or other hardware that, when executing instructions (e.g., embodied in software or firmware), perform any method step disclosed herein. A computing component may include, or be included within, a processor, a computing device like a computer, a controller, an integrated circuit, a “chip”, a system on a chip, a server, other programmable logic devices, other circuitry, or any combination thereof.

“Memory” may be accessible by a machine (e.g., a computing component), such that the machine can read/write information from/to the memory. Memory may be integral with or separate from the machine. Memory may include a non-transitory machine-readable medium having machine-readable program code (e.g., instructions) embodied therein that is adapted to be executed to implement each of the methods and method steps disclosed herein. Memory may include any available storage media, including removable, non-removable, volatile, and non-volatile media—e.g., integrated circuit media, magnetic storage media, optical storage media, or any other computer data storage media. As used herein, machine-readable media includes all forms of machine-readable media except to the extent that such media is deemed to be non-statutory (e.g., transitory propagating signals).

Application programs may carry out aspects by receiving, converting, processing, storing, retrieving, transferring and/or exporting data, which may be stored in a hierarchical, network, relational, non-relational, object-oriented, or other data source. A data source may be a single storage device or realized by multiple (e.g., distributed) storage devices.

All of the information disclosed herein may be represented by data, and that data may be transmitted over any communication pathway using any protocol, stored on a data source, and processed by a computing component. For example, information can be represented by data that is transmitted between devices and/or components using data signals or packets. Transmission of data may be carried out using a variety of wires, cables, radio signals and infrared light beams, and an even greater variety of connectors, plugs and protocols even if not shown or explicitly described. Systems/platforms described herein may exchange information with each other (and with other systems that are not described) using any known or future communication technology, including WiFi, Bluetooth, NFC and other communication network technologies. Carrier waves may be used to transfer data and instructions through electronic, optical, air, electromagnetic, radio frequency, or other signaling media over a network using network transfer protocols, including data that is transferred in data signals. Data, instructions, commands, information, signals, bits, symbols, and chips disclosed herein may be represented by voltages, currents, electromagnetic waves, magnetic fields or particles, optical fields or particles, or any combination thereof.

Different systems/platforms disclosed herein may be geographically dispersed from one another in different regions (e.g., cities, countries), such that different method steps are performed in different regions and by different systems/platforms.

Features in system figures that are illustrated as rectangles may refer to hardware, firmware or software, each of which may comprise a component of a device. It is noted that lines linking two such features may be illustrative of data transfer between those features. Such transfer may occur directly between those features or through intermediate features even if not illustrated. Where no line connects two features, transfer of data between those features is contemplated unless otherwise stated. Thus, such lines are provided to illustrate certain aspects, but should not be interpreted as limiting. The words comprise, comprising, include, including and the like are to be construed in an inclusive sense (i.e., not limited to) as opposed to an exclusive sense (i.e., consisting only of). Words using the singular or plural number also include the plural or singular number, respectively. The words or or and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment. This disclosure is not intended to be limited to the aspects shown herein but is to be accorded the widest scope understood by a skilled artisan, including equivalents.

1. A system for creating codes, creating content with the codes, and tracking use of the codes, wherein the system comprises one or more computing components, wherein the one or more computing components:
identify first content;
generate a first code that includes a first number of characters;
for each of the characters, determine a section in the first content at which to insert that character such that none of the characters will be inserted in the same section; and
generate new content that includes each of the characters inserted at its respective section in the first content.

2. The system of claim 1, wherein the one or more computing components:
generate a first identifier;
associate the first identifier with the first code;
receive a second identifier from a remote computing device;
receive a set of characters from the remote computing device;
compare the second identifier to the first identifier;
if the second identifier and the first identifier do not match, compare the second identifier to another identifier;
if the second identifier and the first identifier match, compare the received set of characters to the characters of the first code; and
if the received set of characters matches the first characters of the first code, generate information that specifies a reward for a recipient who operates the remote computing device.

3. The system of claim 1, wherein the one or more computing components:
transmit the new content to a printing device; and
cause the printing device to print the new content.

4. The system of claim 1, wherein the first content is a work of literature, and wherein each of the characters in the first code is inserted into a different word in the work of literature.

5. The system of claim 1, wherein the first content is a work of literature, and wherein spacing between each consecutive section in the first content is based on the first number and a total number of words in the first content.

6. The system of claim 1, wherein the first content is a work of literature, and wherein spacing between each consecutive section in the first content is based on the first number and a total number of sentences in the first content.

7. The system of claim 1, wherein the first content is a work of literature, and wherein spacing between each consecutive section in the first content is based on the first number and a total number of pages in the first content.

8. The system of claim 1, wherein the one or more computing components:
determine when each of the characters in the first code will display on a remote computing device at different times depending on different detected interactions between a recipient and the new content when displayed on the remote computing device.

9. The system of claim 1, wherein the one or more computing components:
for each character of the characters in the first code, generate instructions that cause that character to display on a remote computing device only after a respective interaction between the recipient and the new content is detected by the remote computing device or the one or more computing devices.

10. The system of claim 2, wherein the one or more computing components:
for each character of the characters in the first code, generate instructions that cause that character to display on a remote computing device only after a respective interaction between the recipient and the new content is detected by the remote computing device or the one or more computing devices.

11. The system of claim 2, wherein the first content is a work of literature, and wherein each of the characters in the first code is inserted into a different word in the work of literature.

12. The system of claim 2, wherein the first content is a work of literature, and wherein spacing between each consecutive section in the first content is based on the first number and a total number of words in the first content.

13. The system of claim 2, wherein the first content is a work of literature, and wherein spacing between each consecutive section in the first content is based on the first number and a total number of sentences in the first content.

14. The system of claim 2, wherein the first content is a work of literature, and wherein spacing between each consecutive section in the first content is based on the first number and a total number of pages in the first content.
